(19) United States
(12) Patent Application Publication
(10) Pub. No.: US 2010/0125406 A1
(43) Pub. Date: May 20, 2010

(54) METHODS, APPARATUSES, AND COMPUTER PROGRAM PRODUCTS FOR PROVIDING POINT OF INTEREST NAVIGATION SERVICES

(75) Inventor: Christian Prehofer, Espoo (FI)

Correspondence Address: ALSTON & BIRD LLP, BANK OF AMERICA PLAZA, 101 SOUTH TRYON STREET, SUITE 4000, CHARLOTTE, NC, 28280-4000, US

(73) Assignee: Nokia Corporation

(21) Appl. No.: 12/273,837

(22) Filed: Nov. 19, 2008

(51) Int. Cl. G01C 21/34; G06Q 30/00

(52) U.S. Cl. 701/201; 701/209; 705/10; 701/206

(57) ABSTRACT

A method, apparatus, and computer program product are provided for providing point of interest navigation services. An apparatus may include a processor configured to receive a request for navigation instructions comprising an origin location and a destination location. The processor may be further configured to determine a route between the origin location and the destination location. The processor may additionally be configured to determine one or more points of interest along the route based at least in part upon prior usage data associated with each point of interest. The prior usage data may be received and aggregated from users of a navigation system. The processor may also be configured to provide navigation instructions comprising the one or more determined points of interest. Corresponding methods and computer program products are also provided.

### TECHNOLOGICAL FIELD

Embodiments of the present invention relate generally to communication technology and, more particularly, relate to methods, apparatuses, and computer program products for providing point of interest navigation services.

### BACKGROUND

The modern communications era has brought about a tremendous expansion of wireline and wireless networks. Computer networks, television networks, and telephony networks are experiencing an unprecedented technological expansion, fueled by consumer demand. Wireless and mobile networking technologies have addressed related consumer demands, while providing more flexibility and immediacy of information transfer.

Current and future networking technologies as well as evolved computing devices making use of networking technologies continue to facilitate ease of information transfer and convenience to users. This explosive growth of mobile communications networks has followed the evolution of mobile devices, such as cellular phones, personal digital assistants (PDAs), and other portable electronic devices from luxury items to ubiquitous devices integrated into the everyday lives of individuals from all walks of life. Mobile electronic devices are now being used to facilitate navigation to a destination location. In this regard, mobile electronic devices such as Global Positioning System (GPS) receivers may provide point-to-point navigation instructions based upon road intersections and road names.

However, some individuals, such as pedestrians, may relate more to points of interest than road names. Further, individuals seeking navigation directions for indoor navigation may not be able to rely on road names as a means for navigation. However, given the overwhelming abundance of points of interest that may be located along a route between an origin location and a destination location, information is needed about points of interest that may facilitate the determination of appropriate points of interest along a route between the origin location and destination location so as to provide meaningful and easy to follow navigation instructions.

Accordingly, it would be advantageous to provide methods, apparatuses, and computer program products for providing point of interest navigation services.

### BRIEF SUMMARY OF SOME EXAMPLES OF THE INVENTION

A method, apparatus, and computer program product are therefore provided for providing point of interest navigation services. In this regard, a method, apparatus, and computer program product are provided that may provide several advantages to a user of a computing device. Embodiments of the invention may provide several advantages to a user of a computing device. For example, embodiments of the invention may provide for point of interest (POI) navigation services. In this regard, embodiments of the invention may provide for a POI navigation system having a plurality of users from whom usage data about POIs may be obtained. Embodiments of the invention may provide navigation instructions including POIs as reference points with POIs determined based at least in part upon the usage data. Accordingly, users may benefit from accurate and useful point of interest navigation instructions. These POI navigation instructions are not limited to use in pedestrian navigation, but may be particularly useful for pedestrians. Further, POI navigation instructions may be the only way to provide navigation instructions for indoor navigation.

In a first exemplary embodiment, a method is provided, which may include receiving a request for navigation instructions comprising an origin location and a destination location. The method may further include determining a route between the origin location and the destination location. The method may additionally include determining one or more points of interest along the route based at least in part upon prior usage data associated with each point of interest. The prior usage data may be received and aggregated from users of a navigation system. The method may also include providing navigation instructions comprising the one or more determined points of interest.

In another exemplary embodiment, a method is provided, which may include storing information about a plurality of points of interest and associated prior usage data for each point of interest. The prior usage data may be received and aggregated from users of a navigation system. The method may further include receiving a request at a computing device for information about a point of interest. The method may additionally include providing information about the point of interest to a user. The method may also include obtaining usage data about the point of interest based at least in part upon the user's interaction with the information about the point of interest. The method may further include updating the stored prior usage data associated with the point of interest based at least in part upon the obtained usage data.

In another exemplary embodiment, a computer program product is provided. The computer program product includes at least one computer-readable storage medium having computer-readable program instructions stored therein. The computer-readable program instructions may include a plurality of program instructions. Although in this summary, the program instructions are ordered, it will be appreciated that this summary is provided merely for purposes of example and the ordering is merely to facilitate summarizing the computer program product. The example ordering in no way limits the implementation of the associated computer program instructions. The first program instruction is for receiving a request for navigation instructions comprising an origin location and a destination location. The second program instruction is for determining a route between the origin location and the destination location. The third program instruction is for determining one or more points of interest along the route based at least in part upon prior usage data associated with each point of interest. The prior usage data may be received and aggregated from users of a navigation system. The fourth program instruction is for providing navigation instructions comprising the one or more determined points of interest.

In another exemplary embodiment, a computer program product is provided. The computer program product includes at least one computer-readable storage medium having computer-readable program instructions stored therein. The computer-readable program instructions may include a plurality of program instructions. Although in this summary, the program instructions are ordered, it will be appreciated that this summary is provided merely for purposes of example and the ordering is merely to facilitate summarizing the computer program product. The example ordering in no way limits the implementation of the associated computer program instructions. The first program instruction is for storing information about a plurality of points of interest and associated prior usage data for each point of interest. The prior usage data may be received and aggregated from users of a navigation system. The second program instruction is for receiving a request at a computing device for information about a point of interest. The third program instruction is for providing information about the point of interest to a user. The fourth program instruction is for obtaining usage data about the point of interest based at least in part upon the user's interaction with the information about the point of interest. The fifth program instruction is for updating the stored prior usage data associated with the point of interest based at least in part upon the obtained usage data.

In another exemplary embodiment, an apparatus is provided, which may include a processor configured to receive a request for navigation instructions comprising an origin location and a destination location. The processor may be further configured to determine a route between the origin location and the destination location. The processor may additionally be configured to determine one or more points of interest along the route based at least in part upon prior usage data associated with each point of interest. The prior usage data may be received and aggregated from users of a navigation system. The processor may also be configured to provide navigation instructions comprising the one or more determined points of interest.

In another exemplary embodiment, an apparatus is provided, which may include a processor configured to store information about a plurality of points of interest and associated prior usage data for each point of interest. The prior usage data may be received and aggregated from users of a navigation system. The processor may be further configured to receive a request at a computing device for information about a point of interest. The processor may additionally be configured to provide information about the point of interest to a user. The processor may also be configured to obtain usage data about the point of interest based at least in part upon the user's interaction with the information about the point of interest. The processor may further be configured to update the stored prior usage data associated with the point of interest based at least in part upon the obtained usage data.

The above summary is provided merely for purposes of summarizing some example embodiments of the invention so as to provide a basic understanding of some aspects of the invention. Accordingly, it will be appreciated that the above described example embodiments are merely examples and should not be construed to narrow the scope or spirit of the invention in any way. It will be appreciated that the scope of the invention encompasses many potential embodiments, some of which will be further described below, in addition to those here summarized.

### BRIEF DESCRIPTION OF THE DRAWING(S)

Having thus described embodiments of the invention in general terms, reference will now be made to the accompanying drawings, which are not necessarily drawn to scale, and wherein:

FIG. 1 illustrates a system for providing point of interest navigation services according to an exemplary embodiment of the present invention;

FIG. 2 is a schematic block diagram of a mobile terminal according to an exemplary embodiment of the present invention;

FIG. 3 illustrates a block diagram of a system for providing a plurality of services, including point of interest navigation services, to computing devices according to an exemplary embodiment of the present invention;

FIG. 4 is a flowchart according to an exemplary method for providing point of interest navigation instructions according to an exemplary embodiment of the present invention; and

FIG. 5 is a flowchart according to an exemplary method for aggregating prior usage data for a point of interest according to an exemplary embodiment of the present invention.

### DETAILED DESCRIPTION

Some embodiments of the present invention will now be described more fully hereinafter with reference to the accompanying drawings, in which some, but not all embodiments of the invention are shown. Indeed, the invention may be embodied in many different forms and should not be construed as limited to the embodiments set forth herein; rather, these embodiments are provided so that this disclosure will satisfy applicable legal requirements. Like reference numerals refer to like elements throughout.

As used herein, a “point of interest” (“POI”) refers to a landmark, structure, monument, sign, building, visible geologic structure, and/or the like. An “active” POI refers to a point of interest that broadcasts a short range radio signal that may be received by a computing device and may uniquely identify the point of interest from which the radio signal was broadcast. “Point of interest navigation” as used herein refers to the use of points of interest to provide navigation instructions. In this regard, points of interest may be used in addition to or in lieu of common street directions. For example, a point of interest navigation instruction may comprise, “Turn left at the red house. In contrast, a street direction navigation instruction may comprise, “Turn left onto Main St.” Embodiments of the invention may provide point of interest navigation instructions for pedestrian and/or automobile navigation and may provide point of interest navigation instructions for outdoor and/or indoor navigation.

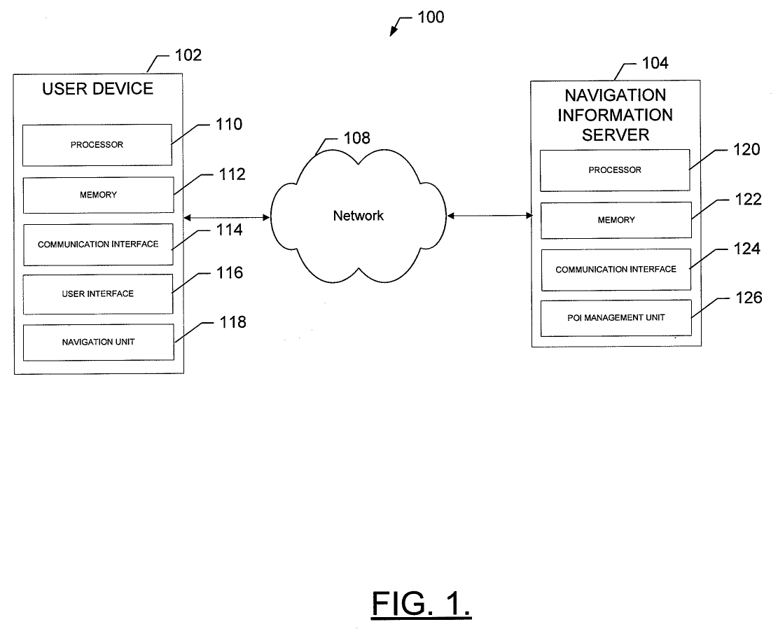

FIG. 1 illustrates a block diagram of a system 100 for providing point of interest navigation services according to an exemplary embodiment of the present invention. As used herein, “exemplary” merely means an example and as such represents one example embodiment for the invention and should not be construed to narrow the scope or spirit of the invention in any way. It will be appreciated that the scope of the invention encompasses many potential embodiments in addition to those illustrated and described herein. As such, while FIG. 1 illustrates one example of a configuration of a system for providing point of interest navigation services, numerous other configurations may also be used to implement embodiments of the present invention.

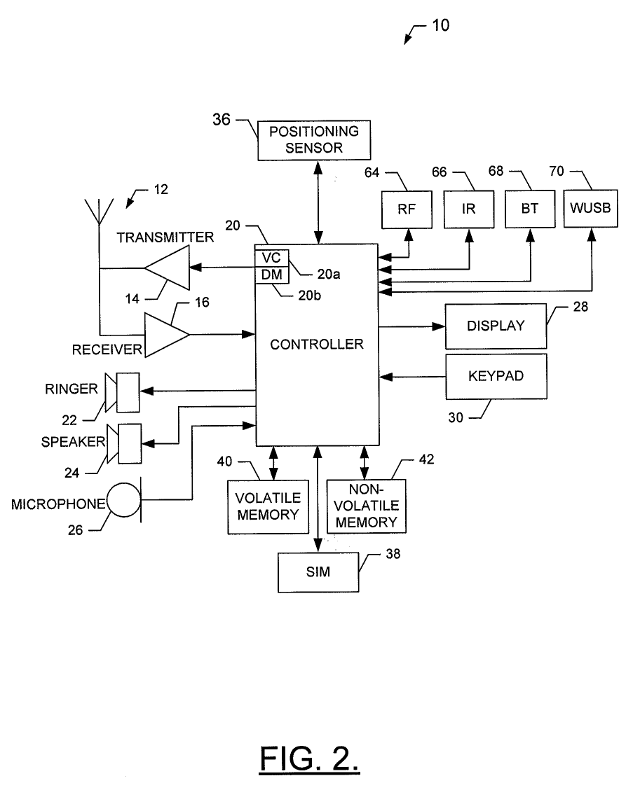

Referring now to FIG. 1, in at least some embodiments, the system 100 includes a user device 102, and navigation information server 104 configured to communicate over a network 108. The network 108 may comprise a wireline network, wireless network, or some combination thereof, and in an exemplary embodiment comprises or is otherwise embodied as the internet. The user device 102 may be embodied as a server, desktop computer, laptop computer, mobile terminal, mobile computer, mobile phone, mobile communication device, game device, digital camera/camcorder, audio/video player, television device, radio receiver, digital video recorder, positioning device, any combination thereof, and/or the like. In an exemplary embodiment, the user device 102 is embodied as a mobile terminal, such as that illustrated in FIG. 2

In this regard, FIG. 2 illustrates a block diagram of a mobile terminal 10 representative of one embodiment of a user device 102 in accordance with embodiments of the present invention. It should be understood, however, that the mobile terminal illustrated and hereinafter described is merely illustrative of one type of user device 102 that may benefit from embodiments of the present invention and, therefore, should not be taken to limit the scope of the present invention. While several embodiments of the electronic device are illustrated and will be hereinafter described for purposes of example, other types of electronic devices, such as mobile telephones, mobile computers, portable digital assistants (PDAs), pagers, laptop computers, desktop computers, gaming devices, televisions, and other types of electronic systems, may employ embodiments of the present invention.

As shown, the mobile terminal 10 may include an antenna 12 (or multiple antennas 12) in communication with a transmitter 14 and a receiver 16. The mobile terminal may also include a controller 20 or other processor(s) that provides signals to and receives signals from the transmitter and receiver, respectively. These signals may include signaling information in accordance with an air interface standard of an applicable cellular system, and/or any number of different wireless networking techniques, comprising but not limited to Wireless-Fidelity (Wi-Fi), wireless local access network (WLAN) techniques such as Institute of Electrical and Electronics Engineers (IEEE) 802.11, and/or the like. In addition, these signals may include speech data, user generated data, user requested data, and/or the like. In this regard, the mobile terminal may be capable of operating with one or more air interface standards, communication protocols, modulation types, access types, and/or the like. More particularly, the mobile terminal may be capable of operating in accordance with various first generation (1G), second generation (2G), 2.5G, third-generation (3G) communication protocols, fourth-generation (4G) communication protocols, and/or the like. For example, the mobile terminal may be capable of operating in accordance with 2G wireless communication protocols IS-136 (Time Division Multiple Access (TDMA)), Global System for Mobile communications (GSM), IS-95 (Code Division Multiple Access (CDMA)), and/or the like. Also, for example, the mobile terminal may be capable of operating in accordance with 2.5G wireless communication protocols General Packet Radio Service (GPRS), Enhanced Data GSM Environment (EDGE), and/or the like. Further, for example, the mobile terminal may be capable of operating in accordance with 3G wireless communication protocols such as Universal Mobile Telecommunications System (UMTS), Code Division Multiple Access 2000 (CDMA2000), Wideband Code Division Multiple Access (WCDMA), Time Division-Synchronous Code Division Multiple Access (TD-SCDMA), and/or the like. The mobile terminal may be additionally capable of operating in accordance with 3.9G wireless communication protocols such as Long Term Evolution (LTE) or Evolved Universal Terrestrial Radio Access Network (E-UTRAN) and/or the like. Additionally, for example, the mobile terminal may be capable of operating in accordance with fourth-generation (4G) wireless communication protocols and/or the like as well as similar wireless communication protocols that may be developed in the future.

Some Narrow-band Advanced Mobile Phone System (NAMPS), as well as Total Access Communication System (TACS), mobile terminals may also benefit from embodiments of this invention, as should dual or higher mode phones (e.g., digital/analog or TDMA/CDMA/analog phones). Additionally, the mobile terminal 10 may be capable of operating according to Wireless Fidelity (Wi-Fi) protocols.

It is understood that the controller 20 may comprise circuitry for implementing audio/video and logic functions of the mobile terminal 10. For example, the controller 20 may comprise a digital signal processor device, a microprocessor device, an analog-to-digital converter, a digital-to-analog converter, and/or the like. Control and signal processing functions of the mobile terminal may be allocated between these devices according to their respective capabilities. The controller may additionally comprise an internal voice coder (VC) 20a, an internal data modem (DM) 20b, and/or the like. Further, the controller may comprise functionality to operate one or more software programs, which may be stored in memory. For example, the controller 20 may be capable of operating a connectivity program, such as a web browser. The connectivity program may allow the mobile terminal 10 to transmit and receive web content, such as location-based content, according to a protocol, such as Wireless Application Protocol (WAP), hypertext transfer protocol (HTTP), and/or the like. The mobile terminal 10 may be capable of using a Transmission Control Protocol/Internet Protocol (TCP/IP) to transmit and receive web content across the internet or other networks.

The mobile terminal 10 may also comprise a user interface including, for example, an earphone or speaker 24, a ringer 22, a microphone 26, a display 28, a user input interface, and/or the like, which may be operationally coupled to the controller 20. As used herein, “operationally coupled” may include any number or combination of intervening elements (including no intervening elements) such that operationally coupled connections may be direct or indirect and in some instances may merely encompass a functional relationship between components. Although not shown, the mobile terminal may comprise a battery for powering various circuits related to the mobile terminal, for example, a circuit to provide mechanical vibration as a detectable output. The user input interface may comprise devices allowing the mobile terminal to receive data, such as a keypad 30, a touch display (not shown), a joystick (not shown), and/or other input device. In embodiments including a keypad, the keypad may comprise numeric (0-9) and related keys (#, *), and/or other keys for operating the mobile terminal.

The mobile terminal 10 may include a positioning sensor 36. The positioning sensor 36 may include, for example, a global positioning system (GPS) sensor, an assisted global positioning system (Assisted-GPS) sensor, etc. In one embodiment, however, the positioning sensor may include a pedometer or inertial sensor. In some embodiments, the positioning sensor 36 is additionally or alternatively configured to determine a location of the mobile terminal using short-range radio signals, such as, for example, WLAN signals, Blue Tooth signals, and/or the like. Further, the positioning sensor may determine the location of the mobile terminal based upon signal triangulation or other mechanisms. The positioning sensor may be configured to determine a location of the mobile terminal, such as latitude and longitude coordinates of the mobile terminal or a position relative to a reference point such as a destination or a start point. Information from the positioning sensor may be communicated to a memory of the mobile terminal or to another memory device to be stored as a position history or location information. Furthermore, a memory of the mobile terminal may store instructions for determining cell id information. In this regard, the memory may store an application program for execution by the controller 20, which may determine an identity of the current cell, i.e., cell id identity or cell id information, with which the mobile terminal is in communication. In conjunction with the positioning sensor, the cell id information may be configured to more accurately determine a location of the mobile terminal.

As shown in FIG. 2, the mobile terminal 10 may also include one or more means for sharing and/or obtaining data. For example, the mobile terminal may comprise a short-range radio frequency (RF) transceiver and/or interrogator 64 so data may be shared with and/or obtained from electronic devices in accordance with RF techniques. The mobile terminal may comprise other short-range transceivers, such as, for example, an infrared (IR) transceiver 66, a Bluetooth™ (BT) transceiver 68 operating using Bluetooth™ brand wireless technology developed by the Bluetooth™ Special Interest Group, a wireless universal serial bus (USB) transceiver 70 and/or the like. The Bluetooth™ transceiver 68 may be capable of operating according to ultra-low power Bluetooth™ technology (e.g., Wibree™) radio standards. In this regard, the mobile terminal 10 and, in particular, the short-range transceiver may be capable of transmitting data to and/or receiving data from electronic devices within a proximity of the mobile terminal, such as within 10 meters, for example. Although not shown, the mobile terminal may be capable of transmitting and/or receiving data from electronic devices according to various wireless networking techniques, including Wireless Fidelity (Wi-Fi), WLAN techniques such as IEEE 802.11 techniques, and/or the like.

The mobile terminal 10 may comprise memory, such as a subscriber identity module (SIM) 38, a removable user identity module (R-UIM), and/or the like, which may store information elements related to a mobile subscriber. In addition to the SIM, the mobile terminal may comprise other removable and/or fixed memory. The mobile terminal 10 may include volatile memory 40 and/or non-volatile memory 42. For example, volatile memory 40 may include Random Access Memory (RAM) including dynamic and/or static RAM, on-chip or off-chip cache memory, and/or the like. Non-volatile memory 42, which may be embedded and/or removable, may include, for example, read-only memory, flash memory, magnetic storage devices (e.g., hard disks, floppy disk drives, magnetic tape, etc.), optical disc drives and/or media, non-volatile random access memory (NVRAM), and/or the like. Like volatile memory 40 non-volatile memory 42 may include a cache area for temporary storage of data. The memories may store one or more software programs, instructions, pieces of information, data, and/or the like which may be used by the mobile terminal for performing functions of the mobile terminal. For example, the memories may comprise an identifier, such as an international mobile equipment identification (IMEI) code, capable of uniquely identifying the mobile terminal 10.

Returning to FIG. 1, the user device 102 is not limited to being embodied as a mobile terminal 10 and as previously described, may be embodied as any computing device, mobile or fixed. The navigation information server 104 may be embodied as any computing device or plurality of computing devices configured to provide POI navigation services to users of the system 100 as will be described further herein. Although referred to as a “server,” it will be appreciated that the navigation information server 104 is not limited to embodiment as a server and may be embodied as any computing device or plurality of computing devices. Although only a single user device 102 is illustrated in FIG. 1, the system 100 may comprise a plurality of user devices 102.

In an exemplary embodiment, the user device 102 includes various means, such as a processor 110, memory 112, communication interface 114, user interface 116, and navigation unit 118 for performing the various functions herein described. These means of the user device 102 as described herein may be embodied as, for example, hardware elements (e.g., a suitably programmed processor, combinational logic circuit, and/or the like), computer code (e.g., software or firmware) embodied on a computer-readable medium (e.g. memory 112) that is executable by a suitably configured processing device (e.g., the processor 110), or some combination thereof. The processor 110 may, for example, be embodied as various means including a microprocessor, a coprocessor, a controller, or various other processing elements including integrated circuits such as, for example, an ASIC (application specific integrated circuit) or FPGA (field programmable gate array). In embodiments wherein the user device 102 is embodied as a mobile terminal 10, the processor 110 may be embodied as or otherwise comprise the controller 20. In an exemplary embodiment, the processor 110 is configured to execute instructions stored in the memory 112 or otherwise accessible to the processor 110. Although illustrated in FIG. 1 as a single processor, in some embodiments the processor 110 comprises a plurality of processors.

The memory 112 may include, for example, volatile and/or non-volatile memory. The memory 112 may be configured to store information, data, applications, instructions, or the like for enabling the user device 102 to carry out various functions in accordance with exemplary embodiments of the present invention. For example, the memory 112 may be configured to buffer input data for processing by the processor 110. Additionally or alternatively, the memory 112 may be configured to store instructions for execution by the processor 110. The memory 112 may comprise one or more databases that store information in the form of static and/or dynamic information. In this regard, the memory 112 may store, for example, navigation information, user location Information, POI information, usage information, and/or the like. This stored information may be stored and/or used by the navigation unit 118 during the course of performing its functionalities.

The communication interface 114 may be embodied as any device or means embodied in hardware, software, firmware, or a combination thereof that is configured to receive and/or transmit data from/to a remote device, such as the navigation information server over the network 108. In at least one embodiment, the communication interface 114 is at least partially embodied as or otherwise controlled by the processor 110. The communication interface 114 may include, for example, an antenna, a transmitter, a receiver, a transceiver and/or supporting hardware or software for enabling communications with other entities of the system 100. The communication interface 114 may be configured to receive and/or transmit data using any protocol that may be used for communications between computing devices of the system 100. The communication interface 114 may additionally be in communication with the memory 112, user interface 116, and/or navigation unit 118, such as via a bus.

In at least some embodiments, the user interface 116 is in communication with the processor 110 to receive an indication of a user input and/or to provide an audible, visual, mechanical, or other output to the user. As such, the user interface 116 may include, for example, a keyboard, a mouse, a joystick, a display, a touch screen display, a microphone, a speaker, and/or other input/output mechanisms. The user interface 116 may be configured to provide means for requesting and receiving navigation instructions and receiving information about POIs. The user interface 116 may be in communication with the memory 112, communication interface 116, and/or navigation unit 118, such as via a bus.

The navigation unit 118 may be embodied as various means, such as hardware, software, firmware, or some combination thereof and, in one embodiment, is embodied as or otherwise controlled by the processor 110. In embodiments where the navigation unit 118 is embodied separately from the processor 110, navigation unit 118 may be in communication with the processor 110. The navigation unit 118 may be configured to provide POI navigation services to a user of a user device 102.

Referring now to the navigation information server 104, embodiments of the navigation information server 104 include various means, such as a processor 120, memory 122, communication interface 124, and POI management unit 126 for performing the various functions herein described. These means of the navigation information server 104 as described herein may be embodied as, for example, hardware elements (e.g., a suitably programmed processor, combinational logic circuit, and/or the like), computer code (e.g., software or firmware) embodied on a computer-readable medium (e.g. memory 122) that is executable by a suitably configured processing device (e.g., the processor 120), or some combination thereof. The processor 120 may, for example, be embodied as various means including a microprocessor, a coprocessor, a controller, or various other processing elements including integrated circuits such as, for example, an ASIC (application specific integrated circuit) or FPGA (field programmable gate array). In an exemplary embodiment, the processor 120 is configured to execute instructions stored in the memory 122 or otherwise accessible to the processor 120. Although illustrated in FIG. 1 as a single processor, in some embodiments, the processor 120 comprises a plurality of processors, which may operate cooperatively, such as in parallel. In embodiments wherein the processor 120 is embodied as a plurality of processors, the plurality of processors may be embodied in a single computing device or in a plurality of computing devices operating cooperatively to implement the navigation information server 104.

The memory 122 may include, for example, volatile and/or non-volatile memory. The memory 122 may be configured to store information, data, applications, instructions, or the like. For example, the memory 122 may be configured to buffer input data for processing by the processor 120. Additionally or alternatively, the memory 122 may be configured to store instructions for execution by the processor 120. The memory 122 may comprise one or more databases that store information in the form of static and/or dynamic information. In this regard, the memory 122 may store, for example, map data, POI information, POI usage data collected and aggregated from a plurality of users of the system 100, and/or the like. This stored information may be stored and/or used by the POI management unit 126 during the course of performing its functionalities.

The communication interface 124 may be embodied as any device or means embodied in hardware, software, firmware, or a combination thereof that is configured to receive and/or transmit data from/to a remote device, such as a user device 102 over the network 108. In one embodiment, the communication interface 124 is at least partially embodied as or otherwise controlled by the processor 120. The communication interface 124 may include, for example, an antenna, a transmitter, a receiver, a transceiver and/or supporting hardware or software for enabling communications with other entities of the system 100. The communication interface 124 may be configured to receive and/or transmit data using any protocol that may be used for communications between computing devices of the system 100. The communication interface 124 may additionally be in communication with the memory 122 and/or POI management unit 126, such as via a bus.

The POI management unit 126 may be embodied as various means, such as hardware, software, firmware, or some combination thereof and, in one embodiment, is embodied as or otherwise controlled by the processor 120. In embodiments wherein the POI management unit 126 is embodied separately from the processor 120, the POI management unit 126 may be in communication with the processor 120. The POI management unit 126 is configured in at least some embodiments to store and manage map data and POI data and may provide POI and map data to the navigation unit 118. The stored and managed POI data may comprise prior usage data associated with each POI, which the POI management unit 126 may obtain and aggregate. In this regard, the POI management unit 126 may comprise and/or manage a database that stores map and/or POI data. The POI management unit 126 may be configured to provide map and POI data to the navigation unit 118 and may receive usage data related to a POI from the navigation unit 118.

Although illustrated in FIG. 1 as being embodied on the user device 102, in some embodiments the navigation unit 118 is instead embodied on the navigation information server 104 or distributed between the user device 102 and navigation information server 104. In this regard, in some embodiments, the navigation unit 118 may, for example, be embodied as or at least partially controlled by the processor 120. For example, in some embodiments, the navigation unit 118 is partially embodied on the navigation information server 104 as a web service that may be accessed from a portion of the navigation unit 118 embodied on the user device 102 that may facilitate user access and viewing of navigation instructions and/or POI information received from the navigation information server 104 over the network 108, such as using a web browser. Thus, wherein, reference is made to the navigation unit 118 sending a request or data to and receiving data from the POI management unit 126, the navigation unit 118 may be configured to send a request or data to and receive data from the navigation information server 104. Reciprocally, where herein reference is made to the POI management unit 126 receiving a request or data from and providing data to the navigation unit 118, the POI management unit 126 may be configured to receive a request or data from and provide data to the user device 102.

In at least some embodiments, the navigation unit 118 is configured to receive a request, such as from a user of the user device 102, for navigation instructions comprising an origin location and a destination location. The origin location may be specifically specified, or may be ascertained by determining a current location for the user device 102. Accordingly, in some embodiments, the navigation unit 118 is configured to determine the current location using a GPS sensor or other positioning sensor or means available to determine a location of the user device 102. Accordingly, the navigation unit 118 may ascertain a location of the user device 102 using, for example, GPS, assisted GPS, a pedometer, inertial sensor, accelerometer, short range radio signals (e.g., WLAN signals, Blue Tooth, RF, and/or the like), signal triangulation, and/or other similar techniques for determining at least an approximate location of the user device 102. In embodiments wherein the user device 102 is embodied as a mobile terminal 10, the navigation unit 118 may use the positioning sensor 36 to determine a current location of the user device 102.

The navigation unit 118 is, in at least some embodiments, further configured to determine a route between the origin location and the destination location and may be configured to do so by using map data that may be accessed from the POI management unit 126. The navigation unit 118 may then access one or more POIs and associated prior usage data from the POI management unit 126 that are located along or near the determined route. These POIs may be stored in a memory, such as, for example, the memory 122 and/or the memory 112.

In some embodiments, the navigation unit 118 is configured to determine one or more POIs from those accessed based at least in part upon the prior usage data associated with each POI. For example, the prior usage data may comprise user feedback data indicating a popularity level of each POI. Additionally or alternatively, the prior usage data may comprise a visibility level of each POI, which may indicate how visible a POI is (may also indicate how easy a POI is to locate if the POI is an active POI). In this regard, the visibility level may indicate how easy a POI is for a user to see based at least in part upon the user's current location (such as may be determined based at least in part upon the location of the user device 102 determined by the navigation unit 118) and/or mode of transportation (e.g., walking, driving, bicycle, and/or the like). For example, a POI may have a high visibility level for a pedestrian approaching the POI from a south-facing side of the POI. However, an object may obstruct a view of a motorist approaching the POI from a north-facing side of the POI.

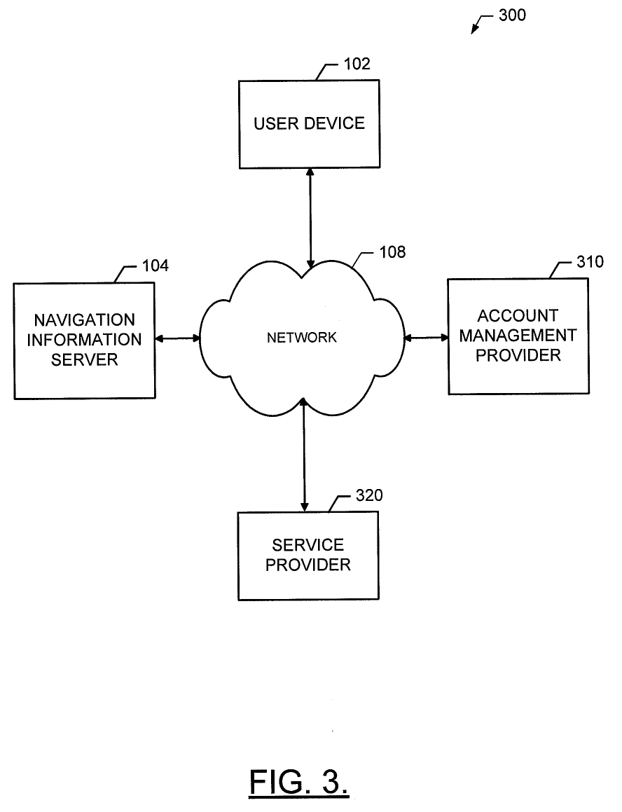

This prior usage data may be obtained and aggregated by the POI management unit 126 from users of the system 100 as will be described further herein below. Additionally or alternatively, this prior usage data may be obtained and aggregated from services provided by other computing devices accessible to the user device 102 and/or the navigation information server 104 and/or from users of such services. For example, FIG. 3 illustrates a system 300 including one or more services from which prior usage data may be obtained in addition to the navigation services provided by the system 100. Accordingly, the navigation unit 118 may be configured to determine one or more POIs based at least in part upon the popularity level and/or visibility level associated with each POI. For example, the navigation unit 118 may be configured to determine a predefined number of POIs having the highest popularity level and/or visibility level among the accessed POIs that are located along or near the determined route. In another example, the navigation unit 118 may be configured to determine a POI over each interval of a predefined distance (e.g., every ¼ mile) along the route and/or at each turn along the route having the highest popularity level and/or visibility level compared to other POIs over an interval or at a turn. In still another example, the navigation unit 118 may be configured to determine POIs along or near the determined route having a popularity level and/or visibility level above a predefined threshold value.

In determining one or more POIs based at least in part upon the popularity level and/or visibility level associated with each POI, the navigation unit 118 may be configured to determine one or more POIs based at least in part upon a user's mode of transportation and/or current location, which may affect a level of visibility of a POI to the user from the user's perspective. Further, a mode of transportation may affect a popularity level of a POI. For example, some POIs may have a higher popularity level if a user is able to interact with the POI, such as by walking through the POI.

In at least some embodiments, the navigation unit 118 is configured to determine one or more points of interest based at least in part upon a 3-D model of a location and/or environment in which a user is currently located. In this regard, the navigation unit 118 may have access to a database comprising images, architectural renderings, blueprints, 3-D models and/or the like of locations and POIs. The database may be stored, for example, on the memory 122 or on some other computing device accessible over the network 108. The navigation unit 118 may be configured to retrieve the available images, renderings, and/or models to generate a 3-D model of a location from a user's point of view to generate a user-perspective model to determine a degree to which a POI is visible to a user. This user perspective view is, for example, advantageous for indoor navigation wherein a POI may be obstructed from a user's view due to the user's position around the corner from a hallway in which the POI is located. Accordingly, the navigation unit 118 may use the determined user-perspective visibility information to determine one or more POIs.

In some embodiments, the navigation unit 118 is configured to determine one or more points of interest based at least in part upon other criteria in lieu of or in addition to visibility and/or popularity of POIs. For example, the navigation unit 118 may be configured to access stored user information, such as may be stored in memory 112 or memory 122, about a user requesting navigation instructions (e.g., a user profile) and determine one or more POIs based at least in part upon the accessed user information. The user information may define user preferences for certain types of POIs, an interval between POIs along a route, POIs which the user has designated as preferred POIs, and/or other similar preferences that may be used by the navigation unit 118 for POI determination when providing navigation instructions. For example, the user may have expressed a preference or the navigation unit 118 may determine the user to have a preference for a category of POIs or a corporate brand name applied to certain POIs. In one example, a user may have a preference for luxury hotels or high end retail. Accordingly, if a POI is a boutique or high end brand name hotel, the navigation unit 118 may determine that a user is more likely to recognize or otherwise be interested in the POI. Similarly, a user may often buy gas at gas stations selling gas from a particular oil company brand name or eat at a particular restaurant chain. Accordingly, if a POI is a gas station of that brand name or restaurant of that restaurant chain, the navigation unit 118 may determine that a user is more likely to recognize or otherwise be interested in the POI. The user information may additionally or alternatively define user demographic information, such as age and sex of the user. As individuals of particular age and/or sex may perceive a POI differently from a user of another age and/or sex, the navigation unit 118 may be configured to determine a POI based at least in part upon demographic information about a user making a request for navigation instructions.

In some embodiments, the navigation unit 118 is configured to additionally or alternatively apply a rating metric that may take into account multiple criteria to determine the one or more POIs based at least in part upon the prior usage data and/or stored user information. This metric may comprise an algorithm that may weight each available criteria in order to determine the one or more POIs. The rating metric may comprise a predefined system default or may be based upon user preferences.

In some embodiments, the navigation unit 118 is configured to provide navigation instructions to a user of the user device 102. In this regard, for example, the navigation unit 118 may be configured to cause navigation instructions to be displayed on a display embodied on or connected to the user device 102. The navigation unit 118 may be configured to provide POI navigation instructions for the entire route between the origin location and the destination location. Additionally or alternatively, the navigation unit 118 may be configured to provide the next predefined number of POIs in the sequence of POIs in the navigation instructions (e.g., the next POI). In this regard, the navigation unit 118 may be configured to track the position of the user device 102 and provide navigation instructions based at least in part upon the user's current location, such as by providing the closest determined POI along the route to the user's current location as a navigation reference point. If the user gets lost or otherwise deviates from the route, the navigation unit 118 may be configured to determine one or more additional POIs and a revised route to the destination location to correct for the user's deviation from the route.

The navigation unit 118 and/or POI management unit 126 are, in some embodiments, further configured to obtain usage data from the user device 102 and/or a user of the user device 102 about a POI so that the POI management unit 126 may update the stored prior usage data associated with the POI. This usage data may be obtained based at least in part upon a user's interaction with POI information provided by the navigation unit 118. Visibility data may be obtained by querying a user as to the visibility of a particular POI. For example, as a user comes to a POI included in navigation instructions provided by the navigation unit 118 (e.g., the navigation unit 118 may determine a current location of the user device 102 by any means previously described and compare the user's current location to the location of the POI), the navigation unit 118 may query the user about the visibility level of the POI. The navigation unit 118 may receive the user's response and provide the response to the POI management unit 126. In one example embodiment, the navigation unit 118 may request that the user click or otherwise select a graphical icon representing a POI once the user has found the POI and may then provide the user with additional directions comprising a next POI along a route to the user's destination location. The navigation unit 118 may additionally or alternatively, for example, provide a user an option within provided navigation instructions to request an additional or alternative POI to assist in navigating the route. If a user requests an additional or alternative POI, the navigation unit 118 may be configured to determine that a POI was not sufficiently visible or otherwise useful to the user. In another example, if a user deviates from a route between an origin location and destination location (e.g., the navigation unit 118 may determine a current location of the user device 102 by any means previously described and determine whether the current location is on the route) for which the navigation unit 118 provided POI navigation instructions, the navigation unit 118 may be configured to determine that a POI used as a reference point in the navigation instructions was not sufficiently visible to the user. Likewise, if the navigation unit 118 determines that the user remains on the route from the origin location to the destination location and/or determines that the user is located at a provided POI, the navigation unit 118 may determine that the POI is visible and/or useful to the user.

The navigation unit 118 and/or POI management unit 126 may be configured to obtain usage data indicating a popularity level of a POI. For example, the navigation unit 118 may be configured to query a user as to the user's interest in a POI as a user comes to a POI included in navigation instructions provided by the navigation unit 118. In another example, the navigation unit 118 may be configured to monitor the location of the user device 102 to determine whether a user is located at a POI and monitor how long the user remains at the POI. A user interest level indicating a popularity of the POI may then be determined based at least in part upon the duration of time that the user is located at the POI (e.g., the longer the user is there, the higher the user's interest level and thus the higher the popularity level).

In another example, the navigation unit 118 and/or POI management unit 126 may be configured to provide information about POIs to a user outside the context of navigation instructions. In this regard, the navigation unit 118 may provide for an interface allowing a user to search for POIs maintained by the POI management unit 126 and may provide a user with information about one or more POIs in response to a user search query. The POI management unit 126 may monitor how many requests are received for information about a POI and use the number of requests to assign a popularity level to the POI. The navigation unit 118 may monitor how long a user views information about a POI. For example, the navigation unit 118 and/or POI management unit 126 may be configured to provide a web page comprising information about a POI in response to a user request and the navigation unit 118 may be configured to monitor how long a user views the web page. The navigation unit 118 and/or POI management unit 126 may be further configured to monitor how many requests are received from users for additional information about a POI. For example, a user may view a summary of information about a POI or may view an indication of a location of a POI on a map and may select to view additional information about a POI.

The navigation unit 118 may be configured to send all obtained usage data to the POI management unit 126, which may be configured to update the prior usage data for a point of interest based at least in part upon the usage data. In this regard, the POI management unit 126 may be configured to aggregate prior usage data obtained from a plurality of users and/or user devices 102 of the system 100 so that the aggregated prior usage data may be used to determine POIs for use in providing navigation instructions as previously described.

In some embodiments, one or more of The POI management unit 126 and navigation unit 118 is configured to obtain data from other services that may be provided by computing devices (such as those illustrated in FIG. 3) in communication with the user device 102 and/or navigation information server 104. This usage data obtained from other services may include, for example, the consumer purchasing habits of users (e.g., preference for certain brand names, companies, and/or the like), user interest in a certain POI or type of POIs expressed through web search/browsing history, and/or the like. In one example embodiment, the navigation unit 118 is configured to monitor a user's usage of the user device 102 and determine user interest in particular POIs or types of POIs. In this regard, for example, the navigation unit 118 may monitor a user's location over time and determine if a user repeatedly visits a particular POI or type of POI. The navigation unit 118 may additionally or alternatively monitor a user's interaction with other applications and services embodied on or accessible to the user device 102 to extrapolate user usage habits that may be used to determine a user interest or preference in a POI or type of POI. Any usage data gathered by the navigation unit 118 may be sent to the POI management unit 126 so that the POI management unit can update the prior usage data for a point of interest based at least in part upon the usage data as previously described.

In some embodiments, the system 100 may comprise a portion of a system for providing a plurality of services to users of computing devices, such as, for example, a user device 102. In this regard, and referring now to FIG. 3, an embodiment of a system 300 for providing a plurality of services, including point of interest navigation services, to computing devices in accordance with aspects of the present invention is illustrated. The system 300 may include an account management provider 310 and a service provider 320 in addition to the elements of the system 100. In this regard, the user device 102, the navigation information server 104, the account management provider 310, and the service provider 320 may be interconnected via the illustrated network 108.

The account management provider 310 may comprise any computing device or plurality of computing devices configured to (e.g., through specially configured hardware, such as, an appropriately configured processor, and/or through specially configured software, such as may be executed by a processor) provide a single service sign-on and/or interface to a plurality of services and/or service providers such that a user of a computing device may access a plurality of services through a single integrated account interface provided by the account management provider 310. Accordingly, in an exemplary embodiment, the account management provider 310 comprises a service provider in that the account management provider 310 provides a gateway to a plurality of services. An example of the functionality that may be provided by an account management provider 310 may be found at Nokia's www.ovi.com. As used herein, “service” may include data or other content as well as services, such as, for example, e-mail, instant messaging, multi-player gaming, peer-to-peer file transfer, web browsing, social networking, photograph hosting, video hosting, and other multimedia hosting services that may be accessed by and/or supplied to remote computing devices over a network or communications link, such as the network 108. In this regard, the provision of POI navigation services by the navigation information server 104 may comprise a service. Accordingly, a user of a computing device may be able to access the navigation information server 104 and/or other computing device providing point of interest navigation services through the account management provider 310. Users may register computing devices, such as, for example, a user device 102, with the account management provider 310 such that the user may access services (e.g., point of interest navigation services) from the account management provider 310 using the user device 102. These services may be provided by the service provider 320 and/or navigation information server 104. Although only one service provider 320 is shown in FIG. 3, the system 300 may comprise a plurality of service providers 320. In this regard, each service provider 320 represents a service provider, such as, for example, a multimedia service provider, which may be accessed through the account management provider 310. In an exemplary embodiment, a service provider 320 is configured to provide POI usage data to the navigation unit 118 and/or POI management unit 126 so that the POI management unit 126 can aggregate and update prior usage data associated with a POI.

Accordingly, a user of a user device 102 may register or otherwise interface a user device 102 with the account management provider 310. Subsequent to registering a user device 102 with the account management provider 310, a user may log into the account management provider 310 and access point of interest navigation services as described in connection to the system 100 from the navigation information server 104.

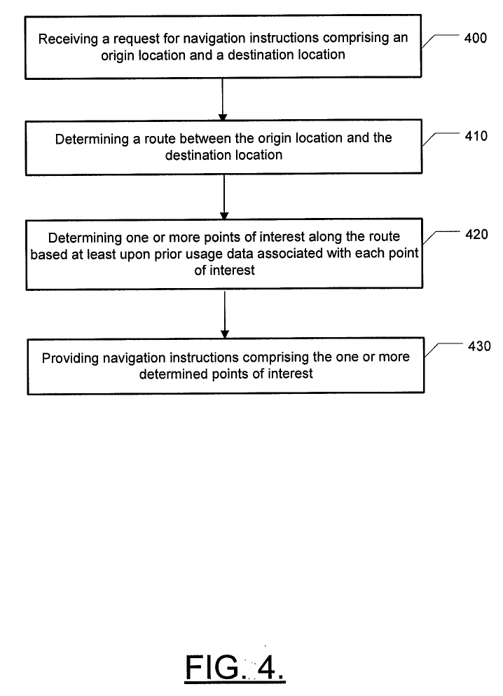

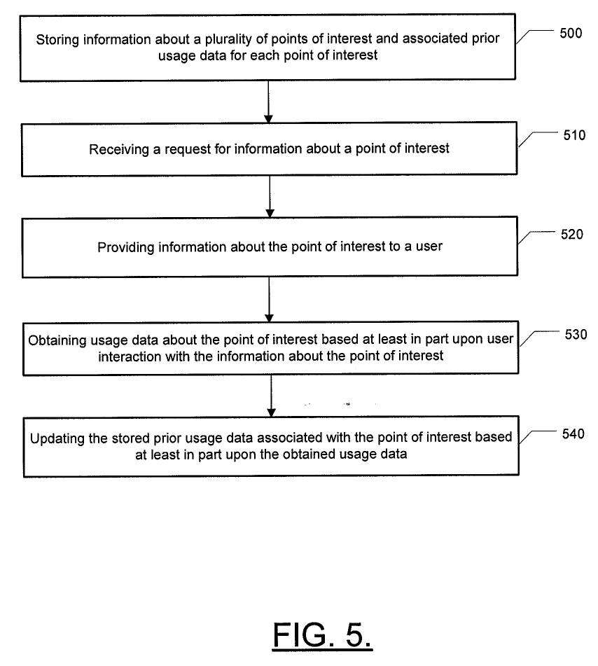

FIGS. 4-5 are flowcharts of systems, methods, and computer program products according to exemplary embodiments of the invention. It will be understood that each block or step of the flowcharts, and combinations of blocks in the flowcharts, may be implemented by various means, such as hardware, firmware, and/or software including one or more computer program instructions. For example, one or more of the procedures described above may be embodied by computer program instructions. In this regard, the computer program instructions which embody the procedures described above may be stored by a memory device of a mobile terminal, server, or other computing device and executed by a processor in the computing device. In some embodiments, the computer program instructions which embody the procedures described above may be stored by memory devices of a plurality of computing devices. As will be appreciated, any such computer program instructions may be loaded onto a computer or other programmable apparatus to produce a machine, such that the instructions which execute on the computer or other programmable apparatus create means for implementing the functions specified in the flowchart block(s) or step(s). These computer program instructions may also be stored in a computer-readable memory that can direct a computer or other programmable apparatus to function in a particular manner, such that the instructions stored in the computer-readable memory produce an article of manufacture including instruction means which implement the function specified in the flowchart block(s) or step(s). The computer program instructions may also be loaded onto a computer or other programmable apparatus to cause a series of operational steps to be performed on the computer or other programmable apparatus to produce a computer-implemented process such that the instructions which execute on the computer or other programmable apparatus provide steps for implementing the functions specified in the flowchart block(s) or step(s).

Accordingly, blocks or steps of the flowcharts support combinations of means for performing the specified functions, combinations of steps for performing the specified functions and program instruction means for performing the specified functions. It will also be understood that one or more blocks or steps of the flowcharts, and combinations of blocks or steps in the flowcharts, may be implemented by special purpose hardware-based computer systems which perform the specified functions or steps, or combinations of special purpose hardware and computer instructions.

In this regard, one exemplary method for providing point of interest navigation instructions according to an exemplary embodiment of the present invention is illustrated in FIG. 4. The method may include the navigation unit 118 receiving a request for navigation instructions comprising an origin location and a destination location, at operation 400. Operation 410 may comprise the navigation unit 118 determining a route between the origin location and the destination location. The navigation unit 118 may then determine one or more points of interest along the route based at least in part upon prior usage data associated with each point of interest, at operation 420. The prior usage data may be received and aggregated from users of a navigation system, such as the point of interest navigation system 100 and/or from a service provider, such as a service provider 320. Operation 430 may comprise the navigation unit 118 providing navigation instructions comprising the one or more determined points of interest to a user of a user device 102.

FIG. 5 illustrates a flowchart according to an exemplary method for aggregating prior usage data for a point of interest according to an exemplary embodiment of the present invention. The method may include the POI management unit 126 storing information about a plurality of points of interest and associated prior usage data for each point of interest, at operation 500. The prior usage data may be received and aggregated from a plurality of users of a point of interest navigation system, such as the system 100, and/or from a service provider, such as a service provider 320. Operation 510 may comprise the POI management unit 126 and/or the navigation unit 118 receiving a request for information about a POI. This request may comprise a user explicitly requesting information about a specific POI or may comprise an implicit request for point of interest navigation instructions that may comprise information about a point of interest as a reference point for the navigation instructions. The navigation unit 118 and/or POI management unit 126 may then provide information about a POI to a user, at operation 520. This provided information may comprise information, such as a written narrative, about a POI, an indication of a POI as a component of POI navigation instructions, and/or the like. Operation 530 may comprise the POI management unit 126 and/or navigation unit 118 obtaining usage data about the POI based at least in part upon user interaction with the information about the POI. This user interaction may comprise, for example, a user using POI navigation instructions to navigate to a destination location, user access and viewing of information about a POI, user feedback about a visibility level of a POI, and/or the like. Operation 540 may comprise the POI management unit 126 updating the stored prior usage data based at least in part upon the obtained usage data.

The above described functions may be carried out in many ways. For example, any suitable means for carrying out each of the functions described above may be employed to carry out embodiments of the invention. In one embodiment, a suitably configured processor may provide all or a portion of the elements of the invention. In another embodiment, all or a portion of the elements of the invention may be configured by and operate under control of a computer program product. The computer program product for performing the methods of embodiments of the invention includes a computer-readable storage medium, such as the non-volatile storage medium, and computer-readable program code portions, such as a series of computer instructions, embodied in the computer-readable storage medium.

As such, then, some embodiments of the invention provide several advantages to a user of a computing device, such as a mobile terminal 10. Embodiments of the invention provide for POI navigation services. In this regard, at least some embodiments of the invention provide for a POI navigation system having a plurality of users from whom usage data about POIs is obtained. At least some embodiments of the invention further provide navigation instructions including POIs as reference points with POIs determined based at least in part upon the usage data. Accordingly, users may benefit from accurate and useful point of interest navigation instructions provided by embodiments of the invention.

Many modifications and other embodiments of the inventions set forth herein will come to mind to one skilled in the art to which these inventions pertain having the benefit of the teachings presented in the foregoing descriptions and the associated drawings. Therefore, it is to be understood that the embodiments of the invention are not to be limited to the specific embodiments disclosed and that modifications and other embodiments are intended to be included within the scope of the appended claims. Moreover, although the foregoing descriptions and the associated drawings describe exemplary embodiments in the context of certain exemplary combinations of elements and/or functions, it should be appreciated that different combinations of elements and/or functions may be provided by alternative embodiments without departing from the scope of the appended claims. In this regard, for example, different combinations of elements and/or functions than those explicitly described above are also contemplated as may be set forth in some of the appended claims. Although specific terms are employed herein, they are used in a generic and descriptive sense only and not for purposes of limitation.

What is claimed is:

1. A method comprising:
receiving, at a computing device, a request for navigation instructions comprising an origin location and a destination location;
determining a route between the origin location and the destination location;
determining one or more points of interest along the route based at least in part upon prior usage data associated with each point of interest, wherein the prior usage data is received and aggregated from one or more of users of a navigation system or a service provider; and
providing navigation instructions comprising the one or more determined points of interest.

2. A method according to claim 1, wherein the prior usage data comprises data indicating a popularity level of each point of interest, and wherein determining one or more points of interest comprises determining one or more points of interest based at least in part upon the popularity level of each point of interest.

3. A method according to claim 1, wherein the prior usage data comprises data indicating a visibility level of each point of interest, and wherein determining one or more points of interest comprises determining one or more points of interest based at least in part upon the visibility level of each point of interest.

4. A method according to claim 1, further comprising accessing stored user information about a user requesting navigation instructions; and wherein determining one or more points of interest further comprises determining one or more points of interest based at least in part upon the user information.

5. A method according to claim 1, wherein the prior usage data comprises a visibility level; and further comprising:
determining whether a user has located a provided point of interest; and
updating the visibility level associated with the point of interest based at least in part upon the determination of whether the user has located the provided point of interest.

6. A method according to claim 1, wherein determining one or more points of interest comprises determining one or more points of interest from a plurality of points of interest stored in a memory.

7. A method comprising:
storing information about a plurality of points of interest and associated prior usage data for each point of interest, wherein the prior usage data is received and aggregated from one or more of users of a navigation system or a service provider;
receiving a request at a computing device for information about a point of interest;
providing information about the point of interest to a user;
obtaining usage data about the point of interest based at least in part upon the user's interaction with the information about the point of interest; and
updating the stored prior usage data associated with the point of interest based at least in part upon the obtained usage data.

8. A method according to claim 7, wherein:
obtaining usage data comprises obtaining usage data about visibility of the point of interest; and
updating the stored prior usage data comprises updating a visibility level associated with the point of interest based at least in part upon the obtained usage data.

9. A method according to claim 8, wherein:
receiving a request for information about a point of interest comprises receiving a request for navigation instructions to a destination location;
providing information about the point of interest comprises providing navigation instructions including the point of interest as a reference point along a route to the destination location; and
obtaining usage data about visibility of the point of interest comprises one or more of determining whether the user has deviated from the route to the destination location based at least in part upon a current location of the user or receiving an indication of a visibility level of the point of interest from the user.

10. A method according to claim 7, wherein:
obtaining usage data from the user comprises obtaining usage data about a popularity level of the point of interest; and
updating the stored prior usage data comprises updating a popularity level associated with the point of interest based at least in part upon the received usage data.

11. A method according to claim 10, wherein obtaining usage data about a popularity level of the point of interest comprises one or more of receiving a user selection of the point of interest, determining that the user is located at the point of interest, receiving a request from the user for additional information about the point of interest, or determining how long the user views the provided information about the point of interest.

12. A computer program product comprising at least one computer-readable storage medium having computer-readable program instructions stored therein, the computer-readable program instructions comprising:
a program instruction for receiving a request for navigation instructions comprising an origin location and a destination location;
a program instruction for determining a route between the origin location and the destination location;
a program instruction for determining one or more points of interest along the route based at least in part upon prior usage data associated with each point of interest, wherein the prior usage data is received and aggregated from one or more of users of a navigation system or a service provider; and
a program instruction for providing navigation instructions comprising the one or more determined points of interest.

13. A computer program product according to claim 12, wherein the prior usage data comprises data indicating a popularity level of each point of interest, and wherein the program instruction for determining one or more points of interest comprises instructions for determining one or more points of interest based at least in part upon the popularity level of each point of interest.

14. A computer program product according to claim 12, wherein the prior usage data comprises data indicating a visibility level of each point of interest, and wherein the program instruction for determining one or more points of interest comprises instructions for determining one or more points of interest based at least in part upon the visibility level of each point of interest.

15. A computer program product according to claim 12, further comprising a program instruction for accessing stored user information about a user requesting navigation instructions; and wherein the program instruction for determining one or more points of interest further comprises instructions for determining one or more points of interest based at least in part upon the user information.

16. A computer program product according to claim 12, wherein the prior usage data comprises a visibility level; and further comprising:
a program instruction for determining whether a user has located a provided point of interest; and
a program instruction for updating the visibility level associated with the point of interest based at least in part upon the determination of whether the user has located the provided point of interest.

17. A computer program product according to claim 12, wherein the program instruction for determining one or more points of interest comprises instructions for determining one or more points of interest from a plurality of points of interest stored in a memory.

18. A computer program product comprising at least one computer-readable storage medium having computer-readable program instructions stored therein, the computer-readable program instructions comprising:
a program instruction for storing information about a plurality of points of interest and associated prior usage data for each point of interest, wherein the prior usage data is received and aggregated from one or more of users of a navigation system or a service provider;
a program instruction for receiving a request for information about a point of interest;
a program instruction for providing information about the point of interest to a user;
a program instruction for obtaining usage data about the point of interest based at least in part upon the user's interaction with the information about the point of interest; and
a program instruction for updating the stored prior usage data associated with the point of interest based at least in part upon the obtained usage data.

19. A computer program product according to claim 18, wherein:
the program instruction for obtaining usage data comprises instructions for obtaining usage data about visibility of the point of interest; and
the program instruction for updating the stored prior usage data comprises instructions for updating a visibility level associated with the point of interest based at least in part upon the obtained usage data.

20. A computer program product according to claim 19, wherein:
the program instruction for receiving a request for information about a point of interest comprises instructions for receiving a request for navigation instructions to a destination location;
the program instruction for providing information about the point of interest comprises instructions for providing navigation instructions including the point of interest as a reference point along a route to the destination location; and
the program instruction for obtaining usage data about visibility of the point of interest comprises instructions for one or more of determining whether the user has deviated from the route to the destination location based at least in part upon a current location of the user or receiving an indication of a visibility level of the point of interest from the user.

21. A computer program product according to claim 18, wherein:
the program instruction for obtaining usage data from the user comprises instructions for obtaining usage data about a popularity level of the point of interest; and
the program instruction for updating the stored prior usage data comprises instructions for updating a popularity level associated with the point of interest based at least in part upon the received usage data.

22. A computer program product according to claim 21, wherein the program instruction for obtaining usage data about a popularity level of the point of interest comprises instructions for one or more of receiving a user selection of the point of interest, determining that the user is located at the point of interest, receiving a request from the user for additional information about the point of interest, or determining how long the user views the provided information about the point of interest.

23. An apparatus comprising a processor configured to:
receive a request for navigation instructions comprising an origin location and a destination location;
determine a route between the origin location and the destination location;
determine one or more points of interest along the route based at least in part upon prior usage data associated with each point of interest, wherein the prior usage data is received and aggregated from one or more of users of a navigation system or a service provider; and
provide navigation instructions comprising the one or more determined points of interest.

24. An apparatus according to claim 23, wherein the prior usage data comprises data indicating a popularity level of each point of interest, and wherein the processor is configured to determine one or more points of interest by determining one or more points of interest based at least in part upon the popularity level of each point of interest.

25. An apparatus according to claim 23, wherein the prior usage data comprises data indicating a visibility level of each point of interest, and wherein the processor is configured to determine one or more points of interest by determining one or more points of interest based at least in part upon the visibility level of each point of interest.

26. An apparatus according to claim 23, wherein the processor is further configured to access stored user information about a user requesting navigation instructions; and wherein the processor is configured to determine one or more points of interest by determining one or more points of interest based at least in part upon the user information.

27. An apparatus according to claim 26, wherein the prior usage data comprises a visibility level; and wherein the processor is further configured to:
determine whether a user has located a provided point of interest; and
update the visibility level associated with the point of interest based at least in part upon the determination of whether the user has located the provided point of interest.

28. An apparatus according to claim 23, wherein the processor is configured to determine one or more points of interest by determining one or more points of interest from a plurality of points of interest stored in a memory.

29. An apparatus comprising a processor configured to:
store information about a plurality of points of interest and associated prior usage data for each point of interest, wherein the prior usage data is received and aggregated from one or more of users of a navigation system or a service provider;
receive a request for information about a point of interest;
provide information about the point of interest to a user;
obtain usage data about the point of interest based at least in part upon the user's interaction with the information about the point of interest; and
update the stored prior usage data associated with the point of interest based at least in part upon the obtained usage data.

30. An apparatus according to claim 29, wherein the processor is configured to:
obtain usage data by obtaining usage data about visibility of the point of interest; and
update the stored prior usage data by updating a visibility level associated with the point of interest based at least in part upon the obtained usage data.

31. An apparatus according to claim 30, wherein the processor is configured to:
receive a request for information about a point of interest by receiving a request for navigation instructions to a destination location;
provide information about the point of interest by providing navigation instructions including the point of interest as a reference point along a route to the destination location; and
obtain usage data about visibility of the point of interest by one or more of determining whether the user has deviated from the route to the destination location based at least in part upon a current location of the user or receiving an indication of a visibility level of the point of interest from the user.

32. An apparatus according to claim 29, wherein the processor is configured to:
obtain usage data from the user by obtaining usage data about a popularity level of the point of interest; and
update the stored prior usage data by updating a popularity level associated with the point of interest based at least in part upon the received usage data.

33. An apparatus according to claim 32, wherein the processor is configured to obtain usage data about a popularity level of the point of interest by one or more of receiving a user selection of the point of interest, determining that the user is located at the point of interest, receiving a request from the user for additional information about the point of interest, or determining how long the user views the provided information about the point of interest.
